(19) United States
(12) Patent Application Publication
(10) Pub. No.: US 2021/0219505 A1
(43) Pub. Date: Jul. 22, 2021

(54) MODULAR COCO COIR GROW BAG SYSTEM FOR CANNABIS

(71) Applicant: Cronos Group Inc., Toronto (CA)

(72) Inventors: Lasse Michael Schulze, Toronto (CA); David Hsu, Toronto (CA)

(21) Appl. No.: 17/051,473

(22) PCT Filed: May 3, 2019
(86) PCT No.: PCT/CA2019/050591

§ 371 Date: Oct. 29, 2020

(30) Foreign Application Priority Data
May 4, 2018 (US) 62/667151

(51) Int. Cl. A01G 24/28; A01G 22/00

(52) U.S. Cl. CPC A01G 24/28; A01G 24/50; A01G 22/00

(57) ABSTRACT

A modular coco coir grow bag system for cannabis plant includes a starter block comprising a growth medium, wherein the growth medium is adapted to receive a peat based plug with a seedling or cutting of the plant. The system further includes a grow bag comprising a growth medium, wherein the growth medium is adapted to receive at least a portion of the starter block. The growth media of the starter block and the grow bag comprises coconut materials, wherein the starter block and grow bag are provided in a compressed format which expands upon hydration. The grow bag further comprises apertures for water drainage and a mesh insert adapted to hinder exit of coarse particulate matter during water drainage.

### CROSS REFERENCE TO PRIOR APPLICATIONS

This application claims priority under the Paris Convention to U.S. provisional patent Application Ser. No. 62/667,151, filed May 4, 2018, which is incorporated herein by reference as if set forth in its entirety.

### FIELD OF THE INVENTION

The present application relates to modular systems and kits for growing plants such as cannabis, as well as methods of growing plants such as cannabis.

### BACKGROUND OF THE INVENTION

It is common practice to transplant seedlings into larger containers as they grow. However, conventional transplanting methods are labor intensive and cause root damage or “root shock” which delays growth and therefore decreases profits, particularly in valuable crops such as cannabis. Attempts to avoid root shock by planting initially in larger containers also has drawbacks, such as insufficient dry-back which leads to overwatered and stunted plants. Use of larger containers also causes inefficient use of space.

There is a need for improved growing systems and methods to improve efficiency, growth and yield of plants such as cannabis. Ideally such growing systems would have sufficient versatility to work with a variety of irrigation systems, designs, and plant sizes and could be used for individual or commercial scale cannabis cultivation.

### SUMMARY OF THE INVENTION

In one embodiment, this application provides a modular system for growing a plant comprising: (a) a starter block comprising a growth medium, wherein the growth medium has an indentation adapted for stably receiving a plug with a seedling or cutting of the plant, wherein the starter block is made of a material which may be penetrated by a root of the seedling or cutting; (b) a grow bag comprising a growth medium, wherein the growth medium has an indentation adapted for stably receiving at least the base of the starter block; wherein the starter block has a larger volume than the plug, and the grow bag has a larger volume than the starter block, so that the plant may be transferred to progressively larger containers without traditional transplanting methods. In certain embodiments, the grow bag has apertures for water draining and a mesh insert adapted to hinder exit of coarse particular matter during water drainage. In certain embodiments, the plant is a cannabis plant, and all of the materials are made of biodegradable material.

In another embodiment, this application provides a kit of parts for growing a cannabis plant, wherein the kit comprises: (a) a starter block comprising a growth medium, wherein the growth medium has an indentation adapted for stably receiving a plug with a seedling or cutting of the cannabis plant, wherein the starter block is made of a material which may be penetrated by a root of the seedling or cutting; and (b) a grow bag comprising a growth medium, wherein the growth medium has an indentation adapted for stably receiving at least the base of the starter block; wherein the starter block has a larger volume than the plug, and the grow bag has a larger volume than the starter block. Optionally the kit may further comprise the plug.

In a further embodiment, this application provides a method of growing cannabis comprising: (a) growing a cannabis seedling or cutting in a plug; (b) when the seedling or cutting has reached a suitable size for transplant, transferring the plug to a starter block comprising a growth medium, wherein the growth medium has an indentation adapted for stably receiving the plug, wherein the starter block is made of a material which may be penetrated by a root of the seedling or cutting; (c) when the seedling or cutting has reached a suitable size for further transplant, transferring the starter block to a grow bag comprising a growth medium, wherein the growth medium has an indentation adapted for stably receiving at least the base of the starter block.

In an aspect, there is provided a system for growing plants comprising a first block comprising a first plant growth medium; and a second block comprising a second plant growth medium, wherein the second block comprises a first block receiver for receiving the first block, wherein the first block receiver comprises a storage mode and a securing mode for reducing movement of the first block when received within the first block receiver.

In some embodiments, the first block receiver comprises a chamber having a depth and a cross-sectional area along a vertical growing axis.

In some embodiments, the depth is shallower in the storage mode than the securing mode.

In some embodiments, the cross-sectional area in the storage mode and the securing mode is approximately equal.

In some embodiments, the cross-sectional area and the depth in the securing mode are configured such that the cross-sectional area and the depth in the securing mode are configured such that a plant root system of a plant contained within the first block protrudes from the sides of the first block proximate to and below a top surface of the second block with the first block received in the block receiver in the securing mode. For plants with lateral roots extending from a tap root system that tend to extend at an angle of deflection from a vertical axis, such placement can increase the available volume for the root system to develop when a plant grown in the first block is placed within the second block as compared to placements where a top surface of the first block is level with the top surface of the second block in the securing mode.

In some embodiments, the addition of water to the second block effects the transition of the block receiver from the storage mode to the securing mode.

In some embodiments, the second plant growth medium comprises coconut material.

In some embodiments, in the storage mode, the coconut material is in a dried compressed state, and the coconut material expands to an uncompressed state upon the addition of water.

In some embodiments, the coconut material comprises crushed coconut, coconut fibres, coconut chunks, coconut peat, coconut coir, or any combination thereof.

In some embodiments, the second medium at full water saturation, has a porosity of from about 27% to about 33% by volume of air. In some embodiments, the second medium has a pH of from about 5.5 to about 6.5. In some embodiments, the second medium has a water holding capacity of from about 4.5 to about 5.5 litres/kg.

In some embodiments, the height of the second block is configured such that water disposed at the base of the second block is imbibed to the top of the second block.

In some embodiments, the first growth medium at full water saturation, has a porosity of from about 17% to about 23% by volume of air. In some embodiments, the first growth medium has a pH of from about 5.5 to about 6.5. In some embodiments, the first growth medium has a water holding capacity of from about 4.5 to about 5.5 litres/kg.

In some embodiments, the system comprises a particulate impeder to reduce the movement of solid material out of the second growth medium. In some embodiments, the particulate impeder is a mesh, filter, open cell foam, or a combination thereof.

In some embodiments, the system comprises a bag, the bag containing the second block, wherein the bag comprises an aperture for the exchange of water between an exterior of the bag and the second block.

In some embodiments, the first block comprises a shroud. In some embodiments, the shroud reduces the egress of the first growth medium such that the first block may be placed within the blocker receiver without extricating any plants contained within the first block. In some embodiments, the shroud is permeable to air, water, soluble nutrients, root of plants grown within the first block, or any combination thereof.

### BRIEF DESCRIPTION OF THE DRAWINGS

FIGS. 1A-D illustrate a first embodiment of the invention. It will be appreciated that this embodiment is illustrative only and not intended to be limiting.

FIG. 1A provides side and top views of a standard, commercially available peat plug which may be used for rooting seedlings and cuttings such as cannabis seedlings and cuttings.

FIG. 1B provides side and top views of a starter block with a growth medium which has an indentation of appropriate dimensions to receive the plug of FIG. 1A.

FIG. 1C provides side, top, and bottom views of a grow bag with a growth medium which has an indentation of appropriate dimensions to fit the starter block of FIG. 1B. In the depicted embodiment, the starter block fits about halfway into the grow bag such that it is stably supported, while enabling breathability from the top and greater space for the roots to grow. FIG. 1C also shows the location of the mesh insert for retaining particulate matter as well as the apertures for water drainage.

FIG. 1D illustrates a cross-section of the modular system with the plug placed in the indentation of the starter block and the starter block placed in the indentation of the grow bag. The root structure is shown penetrating through the plug and starter block and into the grow bag.

FIG. 2 illustrates the conventional coco bag (left) and the modular coco bag system of the current application (right). Picture depicts same cultivar and same plant age.

FIG. 3 illustrates a front view rockwool (left), modular coco bag system of current application (right); picture depicts same cultivar and same plant age.

FIG. 4 illustrates a top view rockwool (top), modular coco bag system of current application (bottom); picture depicts same cultivar and same plant age.

### DESCRIPTION OF THE INVENTION

Exemplary methods and materials are described herein, although methods and materials similar or equivalent to those described herein can also be used in the practice or testing of the present invention. The materials, methods, and examples are illustrative only and not intended to be limiting.

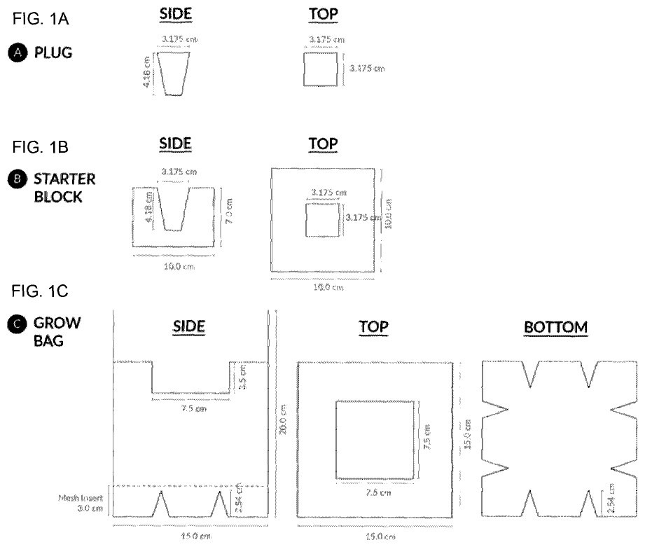

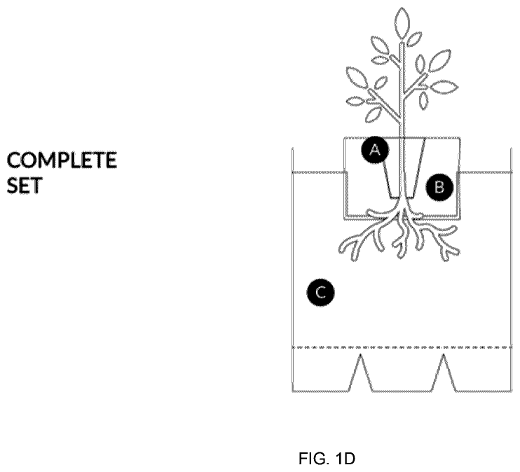

In an aspect, the coco coir grow bag system for cannabis is a modular design to accommodate the different needs for the cannabis plant at varying growth stages, while ensuring uninterrupted growth. The cannabis plant may be rooted in a commercially available standard peat-based plug (see FIG. 1A for sample dimensions).

Then, the rooted cannabis plant may be placed without transplant-shock into a starter block (see FIG. 1B for sample dimensions), which contains an indentation to fit the dimensions of the peat-based plug for quick and seamless insertion. In certain embodiments, the shell of the starter block is made out of a biodegradable cellulose mesh that holds coconut material with a porosity of approximately 17-23% air volume (v/v %) at full water saturation, and a pH of approximately 5.5-6.5. In certain embodiments, the porosity is approximately 20% air volume (v/v %) at full water saturation. In some embodiments, the coconut material comprises crushed coconut husk.

In some embodiments, once the cannabis plant is fully rooted through the starter block, the plant is transplanted into a grow bag (see FIG. 1C for dimensions). The grow bag shell may be constructed out of biodegradable material and have multiple apertures at the bottom to allow water to drain, while a biodegradable cellulose mesh insert prevents coarse particulate matter from exiting the grow bag, e.g. see the 8 slits depicted in FIG. 1C. The grow bag may be filled with a coconut material with a porosity of approximately 27-33% air volume (v/v %) at full water saturation, a water holding capacity of approximately 4.5-5.5 liters/kg, and a pH of approximately 5.5-6.5. In certain embodiments, the porosity is approximately 30% air volume (v/v %) at full water saturation. The top of the growing medium has an indentation for the starter block to fit in the grow bag. In the embodiment shown in FIG. 1C, the starter block sits halfway into the grow bag. In some embodiments, the coconut material comprises crushed coconut husk, coconut fibres, coconut chunks, coconut peat, coconut coir, or any combination thereof.

Both, the starter block and the grow bag may be manufactured in a compressed way, which will expand to the indicated dimensions below, after saturation with water. This reduces storage requirements. A small hole, e.g. a 2-3 mm hole may be drilled into the compressed starter block and grow bag, such that it will have the requisite sized indentation upon expansion.

Features of certain embodiments are discussed below.

Dry-back: Cannabis is an important medicinal plant that requires a consistent growing medium with a high air porosity to allow for sufficient dry-back for a healthy root development. This may be particularly important during early stages of plant growth where the majority of root hairs develop that are responsible for nutrient uptake. Conventional coco coir growing systems do not allow for a sufficient dry-back in these critical early stages, resulting in overwatered and stunted cannabis plants.

No transplant-shock: The modular coco coir grow bag system allows plants to be transplanted from plugs, to smaller starter blocks, to larger grow bags, without injuring the delicate roots. In some embodiments, the smaller block can be placed directly into the larger grow bag, without having to extricate the roots from a growth medium. This may avoid the transplant-shock, and the need for plants to recover from handling that occurs in conventional potting systems (where plants are transplanted into larger pots, which injures roots and can significantly impair growth schedules and yield estimates).

Mesh insert: The mesh insert at the bottom of the grow bag hinders any coarse particulate to exit the grow bag that could clog irrigation lines or inhibit other parts of the irrigation system, such as the UV sterilization. This type of mesh/liner is not used in conventional potting systems, resulting in frequent irrigation line flushes and clean-ups of other irrigation system components and growing tables. The grow bag and/or insert may be made of biodegradable materials for easy disposal and environmental benefits.

Versatility: The grow bag system may be used in an ebb-and-flood irrigation system or with drip irrigation from the top. This may be a significant advantage over traditional growing systems that allow for one, but not the other irrigation type. Additionally, the modular design can allow for the growth of cannabis plants of different sizes and space requirements (e.g. 1-4 ft²), without the need to change to a different pot size or system, which is the case in traditional potting systems. The grow bag system may come in a compressed form. In such embodiments, it is easy to store and takes up much less space in comparison to soil or rockwool media.

Biodegradable bags and organic growing medium: In certain embodiments, all parts of the modular coco coir grow system for cannabis are constructed from biodegradable materials, which allows for a swift harvest and clean out of the growing area, without the need to separate pots from soil or additional waste, as it is the case with non-degradable rockwool.

Organic growing medium: The growing medium may be derived from controlled organic coco coir that can be composted to ensure sustainability of the growing medium. The additional cation exchange capacity of the coco supplies pH and nutrient buffering capacity. Other growing media, such as rockwool, do not biodegrade, are non-organic, and have no cation exchange capacity.

Sterile growing medium: The coco coir may be steamed. In some embodiments, the steaming sterilizes the coco coil, thereby reducing pathogens that could be harmful to the plant or the consumers. In contrast, conventional potting media is not typically sterilized.

Labor efficiency: The transplanting step from plug to starter block to grow bag requires minimal labor, which is an important cost factor in the industry. Traditional potting systems require significantly more labor, which adds to the manufacturing cost of the product.

Pot stability: In some embodiments, the indentations in the starter block and grow bag help ensure a stable base for the plants to grow. This avoids the risk of plants falling over or roots getting damaged when they start to bend sideways.

The methods, systems and kits of the present application could be used for individual or commercial scale cannabis cultivation.

The methods, systems, and kits herein could be used with respect to other types of plants as appropriate.

### EXAMPLES

### Example 1

Cannabis seedlings were planted directly in conventional coco coir bags, however, these large bags have a poor dry-back, which causes the roots of the cannabis plants to rot and limits access to sufficient nutrients for a healthy growth. These traditional coco bags do not have slits, which can allow for drainage and imbibition, or a mesh insert, which can help prevent particulate from clogging irrigation lines and soiling the growing tables, which was observed in this case.

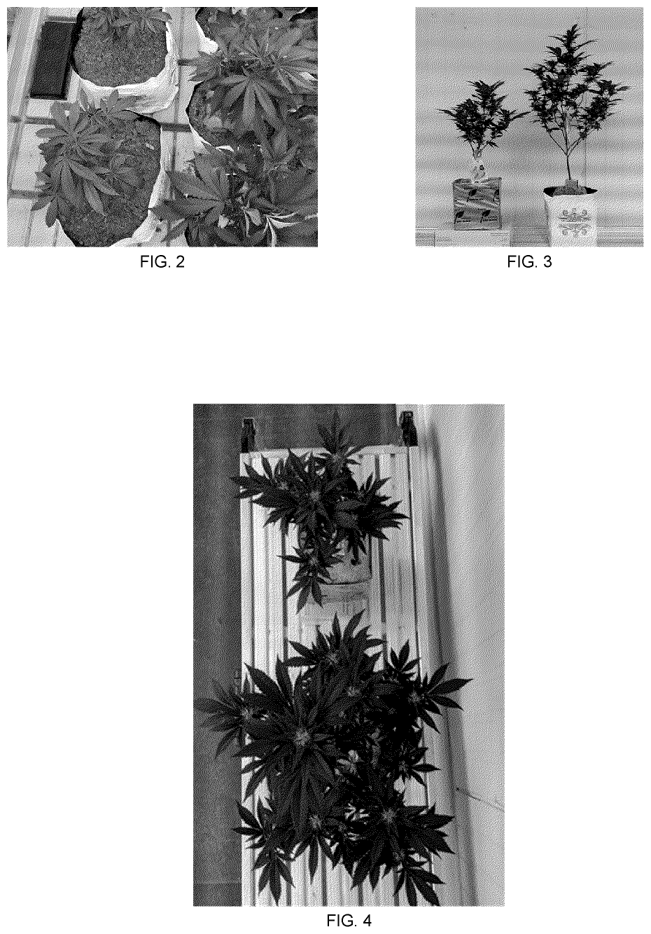

In a side by side comparison with the new coco grow bag system, plants gown in conventional bags appear stunted and show a significantly inferior growth and root development, as shown in FIG. 2.

### Example 2

Cannabis seedling were grown in rockwool cubes of similar shape and volume, but the cannabis plants did not develop well in rockwool, likely due to the lack of organic matter and inferior air porosity for a healthy root growth.

In a side by side comparison with the new coco grow bag system the cannabis plants grown in rockwool were half the size and yielded significantly less product, as shown in FIGS. 3 and 4.

1-16. (canceled)

17. A system for growing plants comprising:
a first block comprising a first plant growth medium; and
a second block comprising a second plant growth medium, wherein the second block comprises a first block receiver for receiving the first block, wherein the first block receiver comprises a storage mode and a securing mode for reducing movement of the first block when received within the first block receiver.

18. The system of claim 17, wherein the first block receiver comprises a chamber having a depth and a cross-sectional area along a vertical growing axis

19. The system of claim 18, wherein the depth is shallower in the storage mode than the securing mode.

20. The system of claim 18, wherein the cross-sectional area and the depth in the securing mode are configured such that a plant root system of a plant contained within the first block protrudes from the sides of the first block proximate to and below a top surface of the second block with the first block received in the block receiver in the securing mode.

21. The system of claim 18, wherein the cross-sectional area in the storage mode and the securing mode is approximately equal.

22. The system of claim 17, wherein the addition of water to the second block effects the transition of the block receiver from the storage mode to the securing mode.

23. The system of claim 17, wherein the second plant growth medium comprises coconut material.

24. The system of claim 23, wherein in the storage mode, the coconut material is in a dried compressed state, and wherein the coconut material expands to an uncompressed state upon the addition of water.

25. The system of claim 23, wherein the coconut material comprises crushed coconut, coconut fibres, coconut chunks, coconut peat, coconut coir, or any combination thereof.

26. The system of claim 17, wherein the second medium at full water saturation, has a porosity of from about 27% to about 33% by volume of air.

27. The system of claim 17, wherein the second medium has a pH of from about 5.5 to about 6.5.

28. The system of claim 17, wherein the second medium has a water holding capacity of from about 4.5 to about 5.5 litres/kg.

29. The system of claim 17, wherein the height of the second block is configured such that water disposed at the base of the second block is imbibed to the top of the second block.

30. The system of claim 17, wherein the first growth medium at full water saturation, has a porosity of from about 17% to about 23% by volume of air.

31. The system of claim 17, wherein the first growth medium has a pH of from about 5.5 to about 6.5.

32. The system of claim 17, wherein the first growth medium has a water holding capacity of from about 4.5 to about 5.5 litres/kg.

33. The system of claim 17, further comprising a particulate impeder to reduce the movement of solid material out of the second growth medium.

34. The system of claim 17, further comprising a bag, the bag containing the second block, wherein the bag comprises an aperture for the exchange of water between an exterior of the bag and the second block.

35. The system of claim 17, further comprising a particulate impeder for reducing the movement of solid material out of the second growth medium.

36. The system of claim 17, wherein in the securing mode, the second block receives the first block such that a top surface of the first block is disposed above a top surface of the second block.
